(19) United States
(12) Patent Application Publication
(10) Pub. No.: US 2012/0179602 A1
(43) Pub. Date: Jul. 12, 2012

(54) Automated Kiosk Transaction Function and Monitoring System

(76) Inventor: Franklin Rodney Wheelock, Margate, FL (US)

(21) Appl. No.: 13/004,217

(22) Filed: Jan. 11, 2011

(51) Int. Cl. G06Q 40/00; G06Q 20/00

(52) U.S. Cl. 705/39; 235/380

(57) ABSTRACT

An automated kiosk system comprises a host server station, at least one automated kiosk, and a communications interface. The host server station receives, stores, and transmits transactional data, monitoring data, and functional data. The at least one automated kiosk facilitates transactions with a consumer and has a user interface, at least one peripheral device, a digital input-output (I/O) board configured to receive the peripheral device(s), and a control system for storing the transactional data, monitoring data, and functional data, and for communicating with the I/O board, the user interface, and the host server station. The communications interface exchanges the transactional data, monitoring data, and functional data between each automated kiosk and the host server station via a network.

### FIELD OF THE INVENTION

The present disclosure relates to automated kiosks, and more particularly to an automated kiosk transaction, function, and monitoring system.

### BACKGROUND OF THE INVENTION

For decades, automated kiosks have been used to provide a variety of retail services for small-value cash transactions without the need for a human attendant to facilitate the transaction. Services provided include bill breaking, coin dispensing, ticket dispensing, and pay stations, among a host of others. In the past, each service required its own separate kiosk. More recently, automated kiosks have been developed to offer multiple services at a single terminal. In addition, kiosks have been configured to communicate information such as sales, inventory, and diagnostics to central host servers.

However, the majority of automated kiosk systems in use today have failed to keep up with the pace of advancements in computer hardware technology. Many automated kiosks utilize analog-only systems, which are limited in memory, processing speed, diagnostics, expansion possibilities, and communication with external systems.

Numerous devices have been developed to provide a system that offers a plurality of retail services at a single kiosk or terminal. For instance, U.S. Pat. No. 7,621,444 to Barcelou discloses an automated transaction machine which provides an integrated system combining multiple services together, such as an automated teller machine (ATM) with a jukebox, an ATM with an Internet retail terminal, or a dating service with a travel ticketing terminal. Such systems avoid duplicating hardware by allowing, for instance, the same control screen to activate both ATM functions and Internet functions.

Such devices are deficient in that they are generally analog-driven systems limited in scope and flexibility. A separate hardware board is required to control each peripheral device (e.g. a credit card reader, bill dispenser, coin acceptor, etc.). Thus, the addition of a supplementary peripheral device requires space in the kiosk not only for the device itself, but also for hardware needed to control the base operations of the device (i.e. firmware). Space constraints severely limit expansion possibilities subsequent to initial production. Programming for additional analog devices must be done using low-level software such as assembly code, requiring the services of a higher-level technician. Analog systems are also limited by memory and speed constraints when it comes to collecting and distributing signals between peripheral devices and a host computer. Any digital features of current designs are generally limited to the use of VGA graphics for information displays.

Such devices are also deficient from the perspective of a diagnostic technician. When an analog driven kiosk system goes down, a technician will generally not immediately know the cause of the problem. Troubleshooting involves a technician on site, removing all suspected defective hardware to a shop, attaching each device to a fully functional system or emulator, and testing wire-by-wire until the defect is found. In addition to the cost of the repair technician, there is the cost associated with a considerable amount of down time for the kiosk.

Devices have also been developed to facilitate diagnostic communications between kiosks and host systems. For example, U.S. Pat. No. 7,325,728 to Arora et al. discloses a system for remote diagnosis and repair of vending machine communication failures. An audit system gathers information from a vending machine controller and transmits the information to a host server. However, the Arora audit system does not perform an analysis of the information received from the vending machine controller, nor does the audit system automatically command the vending machine controller to take action such as disabling a peripheral device or displaying an error message.

Thus it is readily apparent that there is a long felt need for an automated kiosk transaction, function, and monitoring system that overcomes deficiencies in the prior art in the following ways, such as: 1) the system having a host server station capable of receiving and transmitting information to and from a plurality of automated kiosks; 2) the system including at least one digitally driven automated kiosk capable of providing a multiplicity of retail services; 3) each automated kiosk having a digital input-output (I/O) board capable of receiving a plurality of peripheral devices without the need for additional base operation hardware (i.e. the I/O board is plug-and-play); and 4) each automated kiosk configured for analyzing signals from the peripheral devices via the I/O board, for implementing a user interface, and for communicating with the host server station. The present disclosure satisfies the above-mentioned needs, as well as others, and overcomes the deficiencies in devices heretofore developed.

### SUMMARY OF THE INVENTION

The current disclosure presents an automated kiosk transaction function and monitoring system. The system is broadly comprised of a host server station and at least one automated kiosk (or ticket center station). Each automated kiosk has a user interface and is configured to offer any number of small value cash transaction retail services to a user, including but not limited to bill breaking, coin dispensing, ticket dispensing, pay station, lottery ticket validation/payout, and check cashing.

Each automated kiosk contains a control system and an I/O board for connecting peripheral devices. The I/O board is digitally driven and is configured to accept a plurality of peripheral devices through a plug-and-play configuration. Unlike prior art systems which require separate hardware boards for each peripheral device, the digital system of the instant disclosure allows for the base operations of each peripheral device (i.e. the device's firmware) to be built in software directly onto the I/O board. Eliminating the need for excess hardware saves much physical space, is less costly, and allows for easier expansion and upgrades of the system at a later date.

The I/O board is configured to receive any number of devices known in the art that are required to conduct small value cash transactions, including but not limited to user interface screens (LCD, touch screen), card readers and dispensers, bill validators and dispensers, coin hoppers, acceptors, and dispensers, check scanners, ticket readers and dispensers, bar code scanners, fingerprint scanners, printers, and video cameras. The I/O board controls signals to and from all peripheral devices to which it is connected. The I/O board is constantly scanning for new devices and is constantly checking connected devices for errors. Any errors in the system are immediately analyzed and transmitted to the host server station.

It is a general object of the present disclosure to provide a new transaction function and monitoring system that has many of the advantages of the analog and digital connections mentioned heretofore and many new features that result in a new input/output transition board system with minimal hardware load.

It is another object of the present disclosure to provide a system that will overcome the shortcomings of the prior analog devices.

It is still another object of the present disclosure to provide an input/output (I/O) transition board system for peripherals management and system status collecting and distributing signals as needed by the system.

It is yet another object of the present disclosure to track transactional, functional, and monitoring data of multiple automated kiosks, allowing the information to be used for statistical analysis in data management software.

It is another object of the present disclosure to store transactional, functional, and monitoring data in each automated kiosk and in a host server, so that the plurality of data is automatically backed-up and accessible in the event of a network failure.

It is a further object of the present disclosure to provide an I/O board system that allows for attachment of peripheral devices such as, but not limited to, credit card readers, coin hoppers, bill validators, coin acceptors, ticket dispensers, bill dispensers, serial/parallel printer devices, touch screen display, port monitors, check scanners, fingerprint readers, and charge-coupled devices (CCDs) such as digital cameras, video capture devices, and the like.

It is another object of the present disclosure to provide an automated kiosk system with a broad spectrum of communication protocols and RS-232-to-USB interface drivers thus enabling acceptance any of USB, Mini-USB, Micro-USB, RS-232 and Photo-coupling peripheral devices.

It is yet a further object of the present disclosure to provide an automated kiosk system capable of communicating with third-party host servers for the purposes of validating a user's information, for instance verifying zip codes for an ATM machine, or checking bar codes for a lottery-ticket payout machine.

These and other objects, features, and advantages of the present disclosure will become apparent upon a reading of the detailed description and claims in view of the several drawing figures.

### BRIEF DESCRIPTION OF THE DRAWINGS

The disclosure is explained below by means of schematic drawings (see attached) and with additional details. The drawings include:

FIG. 1 is a schematic showing an overview of the automated kiosk transaction function and monitoring system according to the disclosure.

FIG. 2 is a schematic showing the transaction monitoring logic according to the disclosure.

FIG. 3 is a schematic showing the hardware organization of one embodiment of the automated kiosk according to the disclosure.

FIG. 4 is a schematic showing the general firmware structure of the I/O board of the automated kiosk according to the disclosure.

FIG. 5 is a schematic showing the global services of the firmware of the I/O board of the automated kiosk according to the disclosure.

FIG. 6 is a schematic showing the task manager of the firmware of the I/O board of the automated kiosk according to the disclosure.

### DETAILED DESCRIPTION OF THE INVENTION

### Description of Automated Kiosk Transaction Function and Monitoring System

At the outset, it should be clearly understood that like reference numerals are intended to identify the same structural elements, portions, or surfaces consistently throughout the several drawing FIGS., as may be further described or explained by the entire written specification of which this detailed description is an integral part. The drawings are intended to be read together with the specification and are to be construed as a portion of the entire “written description” of this disclosure as required by 35 U.S.C. §112.

Some portions of the detailed description which follows are presented in terms of procedures, steps, logic blocks, processing, and other symbolic representations of operations on data bits that can be performed on computer memory. Each step may be performed by hardware, software, firmware, or combinations thereof.

The automated kiosk system of the present disclosure comprises a host server station, at least one automated kiosk, and a communications interface. The host server station receives, stores, and transmits transactional data, monitoring data, and functional data. Each automated kiosk facilitates transactions with a consumer and has a user interface, at least one peripheral device, a digital input-output (I/O) board configured to receive the peripheral device(s), and a control system for storing the transactional data, monitoring data, and functional data, and for communicating with the I/O board, the user interface, and the host server station. The communications interface exchanges the transactional data, monitoring data, and functional data between each automated kiosk and the host server station via a network.

Automated kiosks are commonly used to provide a variety of small-value cash transaction retail services to a consumer. For example, coin dispensers are often used in Laundromats. When using an automated coin dispensing machine, the consumer will insert paper money into a bill validator and receive coins in return from the machine's coin hopper. It may now be desirable for the Laundromat operator to expand coin dispensing services to include bill breaking. Using prior art analog systems, the operator would need to add a bill dispenser, add a physical board containing firmware for the bill dispenser, and program the user interface of the kiosk in a low-level programming language to control signals from the new board. There must be space in the existing machine for the addition of a new board, and a skilled technician must be called on to program the user interface.

In the preferred embodiment of the present disclosure, the Laundromat operator simply needs to plug-in the bill dispenser and enable bill-breaking using high-level graphical user interface (GUI) software from a host computer. The new peripheral device is plug-and-play, with no additional firmware board or low-level programming required. A countless number of additional examples of use will be readily apparent to those skilled in the art.

The automated kiosk is configured for accepting peripheral devices via plug-and-play technology by incorporating a digitally-driven I/O board into the kiosk. The digital nature of the board allows firmware for peripheral devices (in addition to error codes) to be built in software and stored on the I/O board. The I/O board provides a broad spectrum of communication protocols and RS-232-to-USB interface drivers thus enabling acceptance any of USB, Mini-USB, Micro-USB, RS-232 and Photo-coupling peripheral devices. The I/O board is configured with multiple interfaces for connecting any number of peripheral devices standard in the art, including credit card readers, coin hoppers, bill validators, coin acceptors, ticket dispensers, bill dispensers, serial/parallel printer devices, touch screen display, port monitors, check scanners, fingerprint readers, and charge-coupled devices (CCDs) such as digital cameras, video capture devices, and the like.

In addition, the automated kiosk transaction function and monitoring system is preferably configured to continuously scan all peripheral devices for errors, and to transmit any error information to a host server station. Time normally spent by a technician determining the cause of a problem is greatly reduced or eliminated all together. The technician's time may now be spent repairing devices as opposed to diagnosing problems.

The automated kiosk transaction function and monitoring system is also preferably configured to communicate with third-party host server stations. This can be useful if the application of the kiosk requires the validation of a user's information. For instance, a lottery-payout machine requires a verification of a bar-code from a lottery ticket with a state lottery department. An ATM machine requires verification of a user's zip code before funds are distributed. Each of these operations and others are able to be configured with the present disclosure.

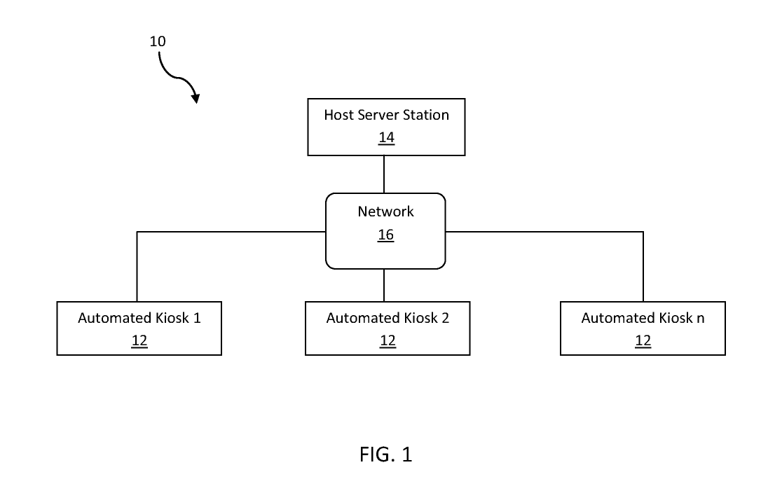

Averting now to the drawings, with reference to FIG. 1, a schematic is depicting an overview of automated kiosk transaction function and monitoring system 10 according to the disclosure. In the preferred embodiment, host server station 14 is connected to at least one automated kiosk 12 via a network 16. Network 16 is preferably a local area network (LAN), but may be a wide area network (WAN), cellular network, or other communication protocol in other embodiments. FIG. 1 depicts a system 10 with three automated kiosks 12 connected, however any number of kiosks 12 may be used. Each automated kiosk 12 is configured to send packets of information to host server station 14. The frequency of transmissions to host server station 14 is varied by kiosk 12, based on the means of network connection. For instance, if kiosk 12 is wired to network 16 with no bandwidth constraints, updating to host server 14 is done continuously. The user is then able to check the status of any automated kiosk 12 remotely in real time. However, if kiosk 12 is connected to a cellular network, transmissions can be limited based on broadband constraints. The transmission rate is fully customizable, for example every 2 minutes, 5 minutes, half hour, etc.

Host server station 14 connected to network 16 is configured with a server monitor program, enabling the user to access any automated kiosk 12 from a remote location as well as track transaction history and errors in the system. The automated kiosks 12 are also each directly connected to network 16. Even if host server station 14 goes down, the individual kiosks 12 continue to operate, and are configured to send information to server 14 when system 10 goes back online.

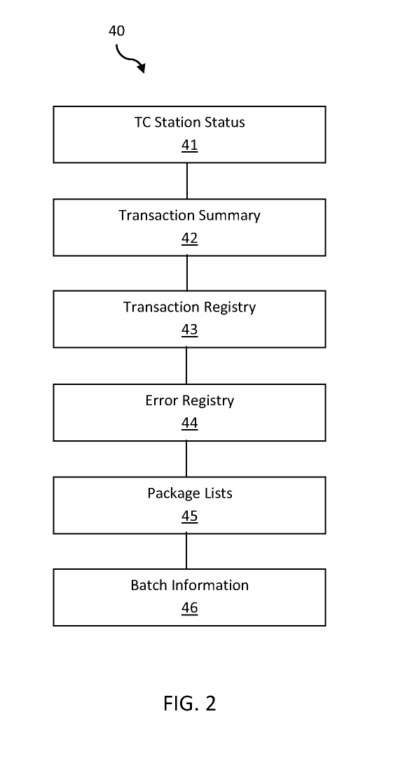

Referring now to FIG. 2, there is depicted a schematic showing transaction monitoring logic 40 according to the disclosure. Each automated kiosk 12 is configured to send to host server station 14 a plurality of status updates simultaneously. These status updates are broken down for display on host server station 14 into Ticket Center (TC) Station Status 41, Transaction Summary 42, Transaction Registry 43, Error Registry 44, Package Lists 45, and Batch Information 46.

TC Station Status 41 displays transactional data, including full details of the last transaction at any chosen automated kiosk 12. The information TC Station Status 41 displays includes a kiosk identifier, packages purchased (quantity and price), bills and coins paid, coin hopper and bill dispenser values, and credit card transaction information. TC Station Status 41 is also configured to provide monitoring data, which includes a list of kiosks 12 that have gone offline, providing a brief description of the root cause of the problem as reported by the I/O board 20 of that particular automated kiosk 12.

Transaction Summary 42 allows the user to see how a particular package has sold during a specific time period, as well as obtain a summary of all payments received broken down by individual kiosk station 12. Transaction Registry 43 contains the details for each individual transaction.

If a peripheral device malfunctions, Error Registry 44 is configured to send to host server station 14 monitoring data including a description of the malfunction based on the manufacturer's error code for the specific device. This represents an improvement over the prior art where a peripheral device malfunction would cause entire system 10 to shut down, requiring a high-level technician physically on site to test each device for errors until the defective device is found. In current system 10, a low-level operator can record the device error, remove the defective device, and send the device off for repair. The high-level technician's time can be spent repairing as opposed to diagnostics.

The system 10 is configured to allow for the user to create multiple Package Lists 45 in addition to standard transactions. For instance, a ticket dispensing machine might be configured to sell tickets priced at one dollar each, or a package of six tickets for five dollars. If the system is connected to a LAN or WAN, Package List 45 data can be edited from host server station 14 and sent to a specific automated kiosk 12 or to all kiosks at once.

The system 10 is also configured to register batches for credit cards on a log via Batch Information 46. Historical data may be displayed for review on a time scale sorted by automated kiosk 12. Batch Information 46 allows the user to check previous batch information, display batches pending release, and to show batches pending a response code from the Credit Card Processor.

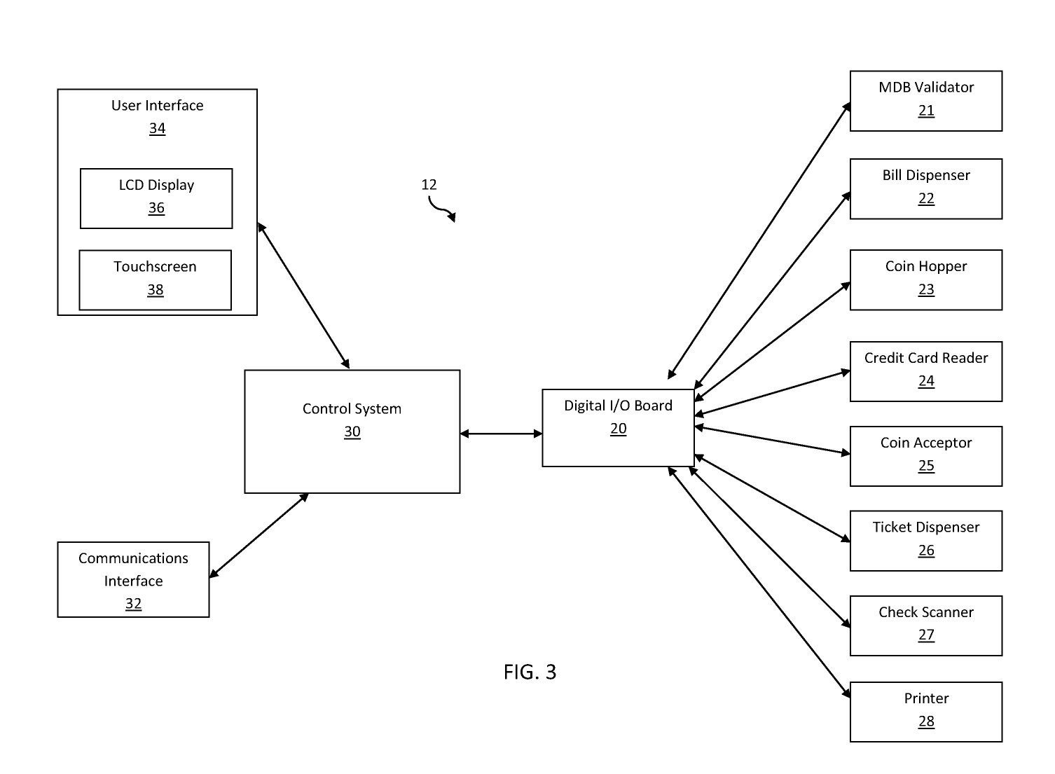

With reference now to FIG. 3, there is depicted a schematic showing the hardware organization of one embodiment of automated kiosk 12 according to the disclosure. Kiosk 12 is comprised primarily of user interface 34, control system 30, digital I/O board 20, communications interface 32, and peripheral devices 20 through 28. I/O board 20 is the interface device for all peripherals 20 through 28. Control system 30 consists of a motherboard configured with kernel software (i.e. an operating system), which controls all data (including functional, transactional, and monitoring data), all signals from I/O board 20, all signals from user interface 34, and all transmissions to and from host server station 14 via communications interface 32. The kernel software can be updated from either host server station 14 or directly from automated kiosk 12. User interface 34 is configured with multiple languages built into the kernel software, allowing the user to select a language when beginning a transaction. The motherboard receives as input a plethora of signals from I/O board 20, from user interface 34, and from host server station 14, and makes decisions via the operating system as to what to do next. FIG. 3 shows I/O board 20 allowing for connection of a plurality of peripheral devices, including MDB validator (bill validator) 21, bill dispenser 22, coin hopper 23, credit card reader 24, coin accepter 25, ticket dispenser 26, check scanner 27, and printer 28. User interface 34 is displayed through VGA LCD screen 36 and is controlled by touch screen 38 via an on-board touch screen keyboard. In other embodiments, user interface 34 is built around any number of analog or digital devices, such as remote/wireless or wired keyboards, Bluetooth-enabled devices, or voice-activated devices.

Digital I/O board 20 is at the heart of the transaction function and monitoring system 10 which enables communications with all types of interactive devices such as daughter boards with relays to operate AC/DC devices. The novel I/O board 20 configuration eliminates the use of large analog, interface systems and brings the desired system monitoring and data reporting capabilities to one I/O device 20 which can control all interface devices and provide audit data for a higher level software device. I/O board 20 can communicate with the peripheral devices in both ccTalk protocol and pulse protocol, the two leading industry standards for peripheral devices.

In the preferred embodiment, I/O board 20 is configured with ports dedicated to the most commonly used peripheral devices, including a MDB validator (bill validator) 21, bill dispenser 22, coin hopper 23, credit card reader 24, coin accepter 25, ticket dispenser 26, check scanner 27, and printer 28. However, in other embodiments I/O board 20 is configured with dedicated ports for additional peripheral devices such as ticket validators, fingerprint readers, and charge-coupled devices (CCDs) such as digital cameras, video capture devices, and the like. I/O board 20 comes equipped with an RS-232 interface allowing for additional peripheral devices to be added as needed. A microprocessor on I/O board 20 controls all signals between the multiple peripheral devices and control system 30. A joint test action group (JTAG) port is also provided on I/O board 20 for debugging and for firmware programming.

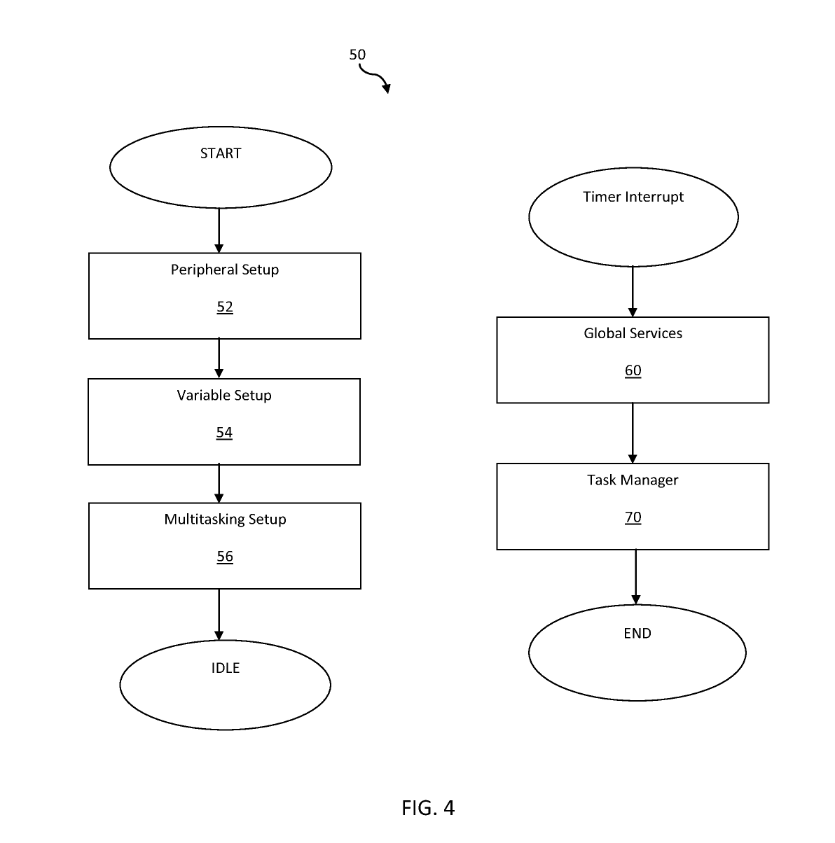

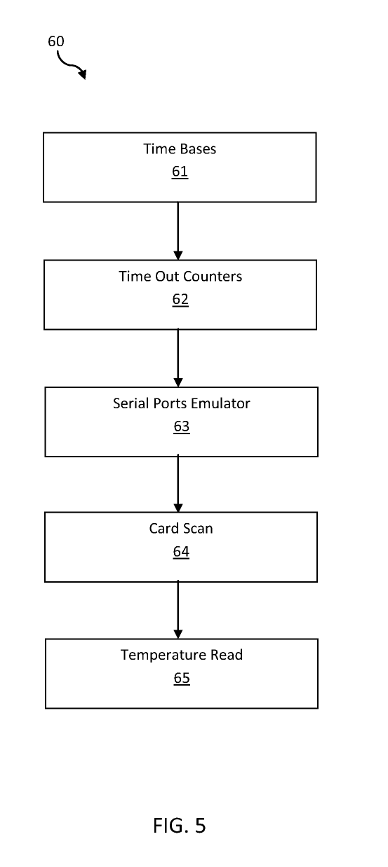

Referring now to FIGS. 4-6, the I/O board's 20 firmware logic is disclosed. FIG. 4 is a schematic showing the general firmware structure 50 of I/O board 20 of automated kiosk 12 according to the disclosure. Upon system startup, Peripheral Setup 52 and Variable Setup 54 automatically run, detecting and initializing all peripheral and variable devices. Next, the I/O board 20 microprocessor is prepared for multitasking via Multitasking Setup 56. The system is then ready to run Global Services 60, which constantly scans the peripheral devices while awaiting input from the user, as shown in FIG. 5.

Referring now to FIG. 5, in the preferred embodiment, after a timer is configured via Time Bases 61 and a counter is updated via Time Out Counters 62, Serial Ports Emulator 63 begins, which checks control system 30 for any input from the motherboard. Input at this time could come from user interface 34 of automated kiosk 12, or from a command sent from host server station 14. If no input is found, Global Services 60 is configured to check the peripheral devices (via Card Scan 64) for input. This accounts for a user who inserts a card/cash into kiosk 12 without first making a selection on user interface screen 38. Finally, if no input is discovered, the temperature of all peripheral devices is scanned and recorded via Temperature Read 65.

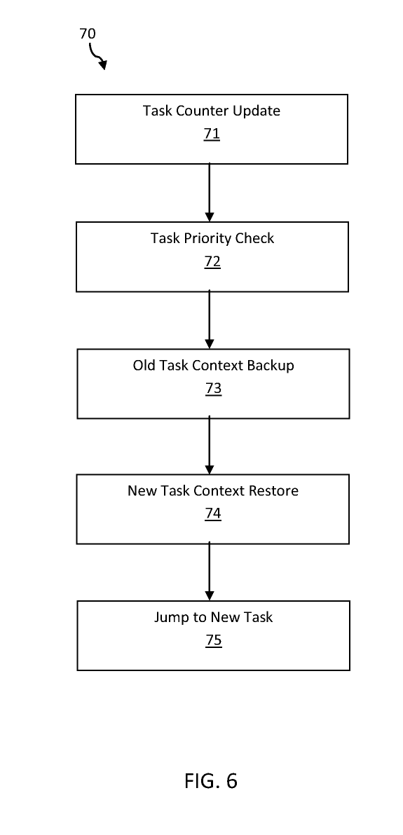

Once an input is discovered, Task Manager 70 is triggered, as shown in FIG. 6. In the preferred embodiment with peripheral devices 20-28, tasks are prioritized by device in the following order: host server 14, credit card reader 24, coin acceptor 25, ticket dispenser 26, printer 28, bill dispenser 22, and then MDB validator 21. However, new priorities are easily configured by the user with the addition or subtraction of peripheral devices in other embodiments of the disclosure. Task Counter Update 71 first determines the number of tasks currently pending. Task Priority Check 72 determines which task to implement based on which peripheral devices are connected and based on user input. For the usual method of conducting retail transactions, communication with control system 30 will generally be given the highest priority, followed by any scanning or acceptor peripherals, followed by any validation peripherals, with the dispensing and printing peripheral devices given the lowest priority. Old Task Context Backup 73 logs and stores relevant data regarding the previous tasks completed, then New Task Context Restore 74 loads the next highest-priority task in line. Once completed, Jump to New Task 75 starts the process over, beginning at Task Counter Update 71.

While a preferred form of this disclosure has been described above and shown in the accompanying drawings, it should be understood that applicant does not intend to be limited to the particular details described above and illustrated in the accompanying drawings, but intends to be limited only to the scope of the disclosure as defined by the following claims. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. An automated kiosk system comprising:
a host server station for receiving, storing, and transmitting transactional data, monitoring data, and functional data; and
at least one automated kiosk for facilitating transactions with a consumer having:
a user interface;
at least one peripheral device;
a digital input-output board configured to receive said at least one peripheral device via a plug-and-play configuration; and
a control system for storing said transactional data, said monitoring data, and said functional data, and for communicating with said user interface, said digital input-output board, and said host server station; and
a communications interface for exchanging said transactional data, said monitoring data, and said functional data between said at least one automated kiosk and said host server station via a network.

2. The automated kiosk system of claim 1, wherein said control system comprises a motherboard and an operating system.

3. The automated kiosk system of claim 1, wherein said digital input-output board is configured to accept said at least one peripheral device via USB, Mini-USB, Micro-USB, and RS-232.

4. The automated kiosk system of claim 1, wherein said at least one peripheral device includes a credit card reader, a coin hopper, a bill validator, a coin acceptor, a ticket dispenser, a bill dispenser, a printer, a touch screen, a port monitor, a check scanner, a fingerprint reader, and a video capture device.

5. The automated kiosk system of claim 1, wherein said user interface is a touch screen.

6. The automated kiosk system of claim 1, wherein said user interface is configured with a plurality of languages.

7. The automated kiosk system of claim 1, wherein said transactional data is data obtained via user input.

8. The automated kiosk system of claim 1, wherein said monitoring data is error data obtained from said digital input-output board via said at least one peripheral device.

9. The automated kiosk system of claim 2, wherein said operating system manipulates said transactional data, said monitoring data, and said functional data.

10. The automated kiosk system of claim 1, wherein said communications interface is a wireless communications interface.

11. The automated kiosk system of claim 1, wherein said network is a local area network (LAN).

12. The automated kiosk system of claim 1, wherein said network is a wide area network (WAN).

13. The automated kiosk system of claim 1, wherein said network is a cellular network.

14. The automated kiosk system of claim 1, wherein a rate of transmission for exchanging said transactional data, said monitoring data, and said functional data between said at least one automated kiosk and said host server station is adjustable.

15. The automated kiosk system of claim 1, wherein said control system is further configured to receive code from said host server station via said network for execution by said control system.

16. The automated kiosk system of claim 1, wherein said transactional data, said monitoring data, and said functional data is stored on each of said at least one automated kiosk and said host server station.

17. The automated kiosk system of claim 1, wherein said digital input-output board communicates with said at least one peripheral device using ccTalk protocol.

18. The automated kiosk system of claim 1, wherein said digital input-output board communicates with said at least one peripheral device using Pulse protocol.

19. The automated kiosk system of claim 1, wherein said control system further communicates with a third-party host server station.
